(19) United States
(12) Patent Application Publication
(10) Pub. No.: US 2005/0263933 A1
(43) Pub. Date: Dec. 1, 2005

(54) Single side bi-directional feed for laser sintering

(75) Inventors: Robert H.W. Welch IV, Austin, TX (US); Tae Mark Chung, Castaic, CA (US); Christopher R. Hanna, Austin, TX (US)

Correspondence Address: 3D Systems, Inc., 26081 Avenue Hall, Valencia, CA, 91355, US

(73) Assignee: 3D Systems, Inc.

(21) Appl. No.: 10/856,289

(22) Filed: May 28, 2004

(51) Int. Cl. B29C 35/08

(52) U.S. Cl. 264/113; 264/497; 425/174.8 R; 425/375

(57) ABSTRACT

An apparatus and a method of using the apparatus to deliver metered quantities of powder to a target area in a laser sintering process from a single sided bi-directional powder delivery system to ensure fresh powder is preheated prior to fusing the powder with a laser beam. Metered quantities of powder are deposited for preheating adjacent the target area and then are spread by a mechanism that traverses the target area.

### BACKGROUND OF THE INVENTION

This invention relates to the field of freeform fabrication, and more specifically is directed to the fabrication of three-dimensional objects by selective laser sintering.

The field of freeform fabrication of parts has, in recent years, made significant improvements in providing high strength, high density parts for use in the design and pilot production of many useful articles. Freeform fabrication generally refers to the manufacture of articles directly from computer-aided-design (CAD) databases in an automated fashion, rather than by conventional machining of prototype articles according to engineering drawings. As a result, the time required to produce prototype parts from engineering designs has been reduced from several weeks to a matter of a few hours.

By way of background, an example of a freeform fabrication technology is the selective laser sintering process practiced in systems available from 3D Systems, Inc., in which articles are produced from a laser-fusible powder in layerwise fashion. According to this process, a thin layer of powder is dispensed and then fused, melted, or sintered, by laser energy that is directed to those portions of the powder corresponding to a cross-section of the article. Conventional selective laser sintering systems, such as the Vanguard system available from 3D Systems, Inc., position the laser beam by way of galvanometer-driven mirrors that deflect the laser beam. The deflection of the laser beam is controlled, in combination with modulation of the laser itself, to direct laser energy to those locations of the fusible powder layer corresponding to the cross-section of the article to be formed in that layer. The computer based control system is programmed with information indicative of the desired boundaries of a plurality of cross sections of the part to be produced. The laser may be scanned across the powder in raster fashion, with modulation of the laser affected in combination therewith, or the laser may be directed in vector fashion. In some applications, cross-sections of articles are formed in a powder layer by fusing powder along the outline of the cross-section in vector fashion either before or after a raster scan that “fills” the area within the vector-drawn outline. In any case, after the selective fusing of powder in a given layer, an additional layer of powder is then dispensed, and the process repeated, with fused portions of later layers fusing to fused portions of previous layers as appropriate for the article, until the article is complete.

Detailed description of the selective laser sintering technology may be found in U.S. Pat. Nos. 4,863,538; 5,132,143; and 4,944,817, all assigned to Board of Regents, The University of Texas System, and in U.S. Pat. No. 4,247,508 to Housholder, all hereby incorporated by reference.

The selective laser sintering technology has enabled the direct manufacture of three-dimensional articles of high resolution and dimensional accuracy from a variety of materials including polystyrene, some nylons, other plastics, and composite materials such as polymer coated metals and ceramics. Polystyrene parts may be used in the generation of tooling by way of the well-known “lost wax” process. In addition, selective laser sintering may be used for the direct fabrication of molds from a CAD database representation of the object to be molded in the fabricated molds; in this case, computer operations will “invert” the CAD database representation of the object to be formed, to directly form the negative molds from the powder.

FIG. 1 illustrates, by way of background, a rendering of a conventional selective laser sintering system currently sold by 3D Systems, Inc. of Valencia, Calif. FIG. 1 is a rendering shown without doors for clarity. A carbon dioxide laser and its associated optics are shown mounted in a unit above a process chamber that includes a powder bed, two feed powder cartridges, and a leveling roller. The process chamber maintains the appropriate temperature and atmospheric composition for the fabrication of the article. The atmosphere is typically an inert atmosphere, such as nitrogen.

Operation of this conventional selective laser sintering system is shown in FIG. 2 in a front view of the process with the doors removed for clarity. A laser beam 104 is generated by laser 108, and aimed at target surface or area 110 by way of scanning system 114 that generally includes galvanometer-driven mirrors which deflect the laser beam. The laser and galvonometer systems are isolated from the hot chamber 102 by a laser window 116. The laser window 116 is situated within radiant heater elements 120 that heat the target area 110 of the part bed below. These heater elements 120 may be ring shaped (rectangular or circular) panels or radiant heater rods that surround the laser window 116. The deflection and focal length of the laser beam are controlled, in combination with the modulation of laser 108 itself, to direct laser energy to those locations of the fusible powder layer corresponding to the cross-section of the article to be formed in that layer. Scanning system 114 may scan the laser beam across the powder in a raster-scan fashion, or in vector fashion. It is understood that scanning entails the laser beam intersecting the powder surface in the target area 110.

Two feed systems (124,126) feed powder into the system by means of push-up piston systems. A part bed 132 receives powder from the two feed pistons as described immediately hereafter. Feed system 126 first pushes up a measured amount of powder and a counter-rotating roller 130 picks up and spreads the powder over the part bed in a uniform manner. The counter-rotating roller 130 passes completely over the target area 110 and part bed 132. Any residual powder is deposited into an overflow receptacle 136. Positioned nearer the top of the chamber are radiant heater elements 122 that pre-heat the feed powder and a ring or rectangular shaped radiant heater element 120 for heating the part bed surface. Element 120 has a central opening which allows a laser beam to pass through the laser window 116. After a traversal of the counter-rotating roller 130 across the part bed 132 the laser selectively fuses the layer just dispensed. The roller then returns from the area of the overflow receptacle 136, after which the feed piston 124 pushes up a prescribed amount of powder and the roller 130 dispenses powder over the target area 110 in the opposite direction and proceeds to the other overflow receptacle 138 to deposit any residual powder. Before the roller 130 begins each traverse of the part bed 132 the center part bed piston 128 drops by the desired layer thickness to make room for additional powder.

The powder delivery system in system 100 includes feed pistons 125 and 127. Feed pistons 125 and 127 are controlled by motors (not shown) to move upwardly and lift, when indexed, a volume of powder into chamber 102. Part piston 128 is controlled by a motor (not shown) to move downwardly below the floor of chamber 102 by a small amount, for example 0.125 mm, to define the thickness of each layer of powder to be processed. Roller 130 is a counter-rotating roller that translates powder from feed systems 124 and 126 onto target surface 110. When traveling in either direction the roller carries any residual powder not deposited on the target area into overflow receptacles (136,138) on either end of the process chamber 102. Target surface 110, for purposes of the description herein, refers to the top surface of heat-fusible powder (including portions previously sintered, if present) disposed above part piston 128; the sintered and unsintered powder disposed on part piston 128 will be referred to herein as part cake 106. System 100 of FIG. 2 also requires radiant heaters 122 over the feed pistons to pre-heat the powders to minimize any thermal shock as fresh powder is spread over the recently sintered and hot target area 110. This type of dual piston feed system, providing fresh powder from below the target area, with heating elements for both feed beds and the part bed is implemented commercially in the Vanguard™ selective laser sintering system sold by 3D Systems, Inc. of Valencia, Calif.

Another known powder delivery system uses overhead hoppers to feed powder from above and either side of target area 110 in front of a delivery apparatus such as a wiper or scraper.

There are advantages and disadvantages to each of these systems. Both require a number of mechanisms, either push-up pistons or overhead hopper systems with metering feeders to effectively deliver metered amounts of powder to each side of the target area and in front of the spreading mechanism which typically is either a roller or a wiper blade.

Although a design such as system 100 has proven to be very effective in delivering both powder and thermal energy in a precise and efficient way there is a need to do so in a more cost effective manner by reducing the number of mechanisms and improve the pre-heating of fresh powder to carry out the selective laser sintering process.

### BRIEF SUMMARY OF THE INVENTION

It is an aspect of the present invention to provide a method and apparatus for fabricating objects by selective laser sintering employing fewer mechanisms.

It is another aspect of the present invention to provide a method and apparatus for fabricating objects by selective laser sintering which deposits all of the powder from an overhead feed system that is needed to form two successive cross-sectional layers on one side of a target area and which concurrently levels the powder for the first successive layer while transporting the powder for the second successive layer to an opposing second side of the target area.

It is a feature of the present invention that a method and apparatus for fabricating objects via selective laser sintering are provided without sacrificing good thermal control and good powder delivery.

It is another feature of the present invention that a modified process and an apparatus that utilize only one overhead feed hopper and no feed pistons with radiant heaters are provided.

It is another feature of the present invention that the second powder wave used to form the second layer of powder is preheated in a parked position within the process chamber while the laser beam scans the first layer of powder.

It is an advantage of the present invention that an apparatus and a method for employing that apparatus are provided for fabricating objects with a selective laser sintering system having a smaller machine footprint.

It is another advantage of the present invention that the method and apparatus are achieved at a lower cost than prior laser sintering systems.

The invention includes a method for forming a three dimensional article by laser sintering that includes at least the steps of: depositing a quantity of powder on a first side of a target area; spreading the powder with a spreading mechanism to form a first smooth surface; directing an energy beam over the target area causing the powder to form an integral layer; depositing a quantity of powder on an opposing second side of the target area; spreading the powder with the spreading mechanism to form a second smooth surface; directing the energy beam over the target area causing powder to form a second integral layer bonded to the first integral layer; and repeating the steps to form additional layers that are integrally bonded to adjacent layers so as to form a three-dimensional article, wherein the depositing step includes at least depositing all of the powder required for two successive layers on the first side of the target area and concurrently spreading the powder for the first successive layer while transporting the powder for the second successive layer to the opposing second side of the target area on the spreading mechanism, the powder for the second successive layer being dislodged by an appropriate device during a second depositing step.

The invention also includes an apparatus for producing parts from a powder comprising a chamber having a target area at which an additive process is performed, the target area having a first side and an opposing second side; a means for fusing selected portions of a layer of the powder at the target area; a powder feed hopper located above and on the first side of the target area for feeding desired amounts of the powder; a means for spreading a first layer of powder over the target area while carrying a second quantity of powder to the opposing second side of the target area to be used for a second layer of powder; and a means for depositing the second quantity of powder on the opposing second side of target area.

### BRIEF DESCRIPTION OF DRAWINGS

These and other aspects, features and advantages of the invention will become apparent upon consideration of the following detailed disclosure, especially when taken in conjunction with the accompanying drawings wherein:

FIG. 1 is a diagrammatic illustration of a prior art selective laser sintering machine with portions cut away;

FIG. 2 is a diagrammatic front elevational view of a conventional prior art selective laser sintering machine showing some of the mechanisms involved;

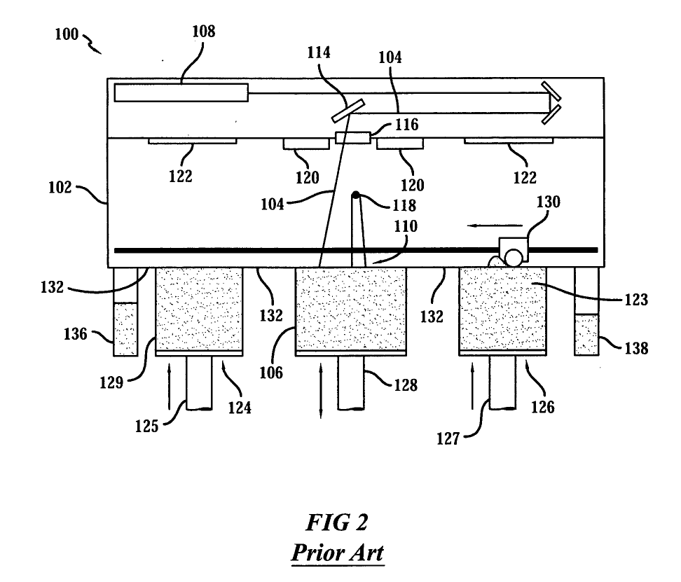

FIG. 3 is a diagrammatic front elevational view of the system of the present invention showing the metering of the powder in front of the roller mechanism;

FIG. 4 is a second diagrammatic front elevational view of the system of the present invention showing the parking of the powder wave near the part bed;

FIG. 5 is a third diagrammatic front elevational view of the system of the present invention showing the retraction of the roller mechanism and the parking of the roller mechanism under the feed mechanism while the laser is selectively heating the part bed and the part bed heater is pre-heating the parked powder wave;

FIG. 6 is a fourth diagrammatic front elevational view of the system of the present invention showing the dispensing of the second layer of powder onto the top of the roller mechanism;

FIG. 7 is a fifth diagrammatic front elevational view of the system of the present invention showing the first layer of powder being distributed across the target area and the second layer of powder being carried on top of the roller mechanism to the other side of the target area;

FIG. 8 is a sixth diagrammatic front elevational view of the system of the present invention showing the depositing of the second layer of powder adjacent to the roller on the opposing side of the powder bed and depositing of residual powder from the first layer in an overflow receptacle;

FIG. 9 is the seventh diagrammatic front elevational view of the system of the present invention showing the parking of the second powder wave near the part bed;

FIG. 10 is an eighth diagrammatic view of the system of the present invention showing the parking of the roller to the side while the laser is selectively heating the part bed and the part bed heater is pre-heating the parked powder wave;

FIG. 11 is a ninth diagrammatic front elevational view of the system of the present invention showing the second layer of powder being distributed across the target area; and

FIG. 12 is a tenth diagrammatic front elevational view of the system of the present invention showing the roller completing one cycle by depositing residual powder in a second overflow receptacle.

### DETAILED DESCRIPTION OF THE INVENTION

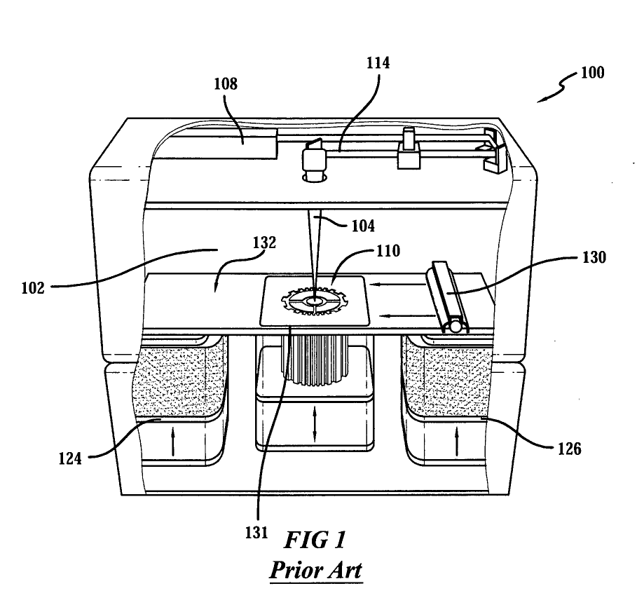

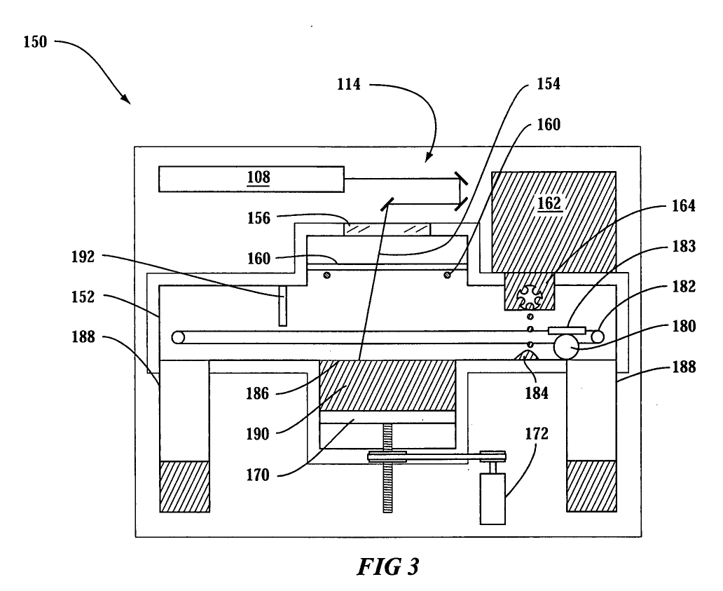

An apparatus for carrying out the present invention can be seen in FIG. 3 and is shown generally as 150. The process chamber is shown as 152. The laser beam 154 enters through a laser window 156 that isolates the laser and optics (not shown) of the same type as described with respect to FIG. 1 from the higher temperature environment of the process chamber 152. Radiant heating elements 160 provide heat to the part bed and to the areas immediately next to the part bed. These radiant heating elements can be any number of types including, for example, quartz rods or flat panels. A preferred design is fast response quartz rod heaters.

A single powder feed hopper 162 is shown with a bottom feed mechanism 164 controlled by a motor (not shown) to control the amount of powder dropped onto the bed below. The feed mechanism can be of several types including, for example, a star feeder, an auger feeder, or a rotary drum feeder. A preferred feeder is a rotary drum. A part piston 170 is controlled by a motor 172 to move downwardly below the floor of the chamber 152 by a small amount, for example 0.125 mm, to define the thickness of each layer of powder to be processed.

Roller mechanism 180 includes a counter-rotating roller driven by motor 182 that spreads powder from powder wave 184 across the laser target area 186. When traveling in either direction the roller mechanism 180 carries any residual powder not deposited on the target area into overflow receptacles 188 on opposing ends of the chamber. Target area 186, for purposes of the description herein, refers to the top surface of heat-fusible powder, including any portions previously sintered, disposed above part piston 170. The sintered and unsintered powder disposed on part piston 170 will be referred to as part bed 190. Although the use of counter-rotating roller mechanism 180 is preferred, the powder can also be spread by other means such as a wiper or a doctor blade.

Operation of the selective laser sintering system of this invention is shown beginning in FIG. 3. In a first powder dispensing step a quantity of powder is metered from above from the hopper 162 by the bottom feed mechanism 164 to a position in front of the roller mechanism 180. The quantity of powder metered will depend upon the size of the target area 186 to be covered and the desired layer thickness to be formed. The deposited quantity of powder appears as a mound, but will be referred to hereinafter as a parked powder wave. Parked powder wave 184 shown in FIG. 3 can contain from about 2.9 to about 8.0 cubic inches of powder when layer thicknesses of from about 0.003 inches (0.0762 mm) to about 0.008 inches (0.203 mm) are desired in each layer formed.

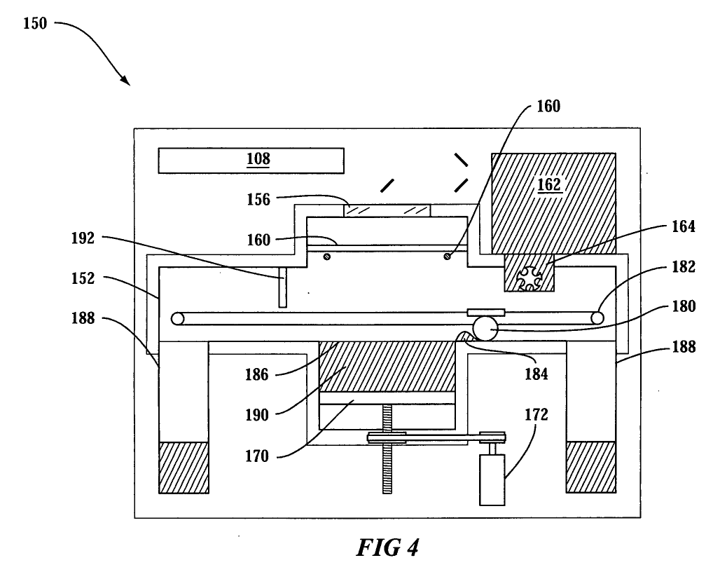

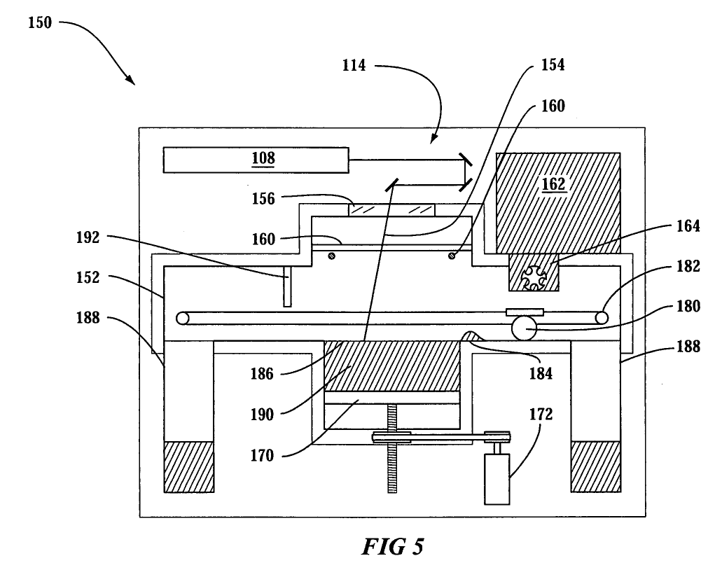

In a second step, shown in FIG. 4, the counter-rotating roller mechanism 180 is activated to move the powder wave 184 slightly forward and park it at the edge of the target area 186 on a first side in view of the radiant heating elements 160. In a third step, shown in FIG. 5, the roller mechanism 180 is moved back and parked directly under the feed hopper 162. In iterations other than for the first quantity of powder metered from the feed mechanism 164, the laser (not shown) is then turned on and the laser beam 154 scans the current layer to selectively fuse the powder on that layer. While the laser is scanning the roller mechanism 180 remains parked with its powder support surface or powder carrying structure 183 directly under the powder feeder hopper 162. Also while the laser is scanning, the parked powder wave 184 adjacent the first side of the target area 186 is pre-heated by the action of the radiant heating elements 160. This step can eliminate the need for separate radiant heaters to pre-heat the powder.

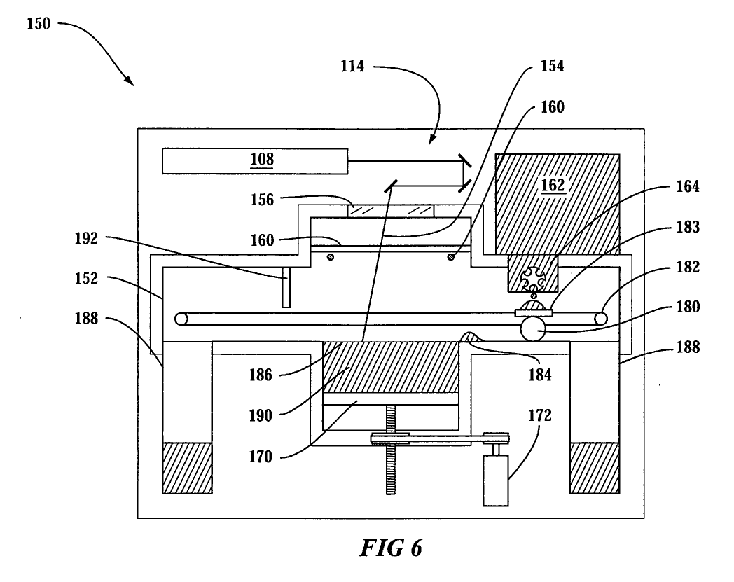

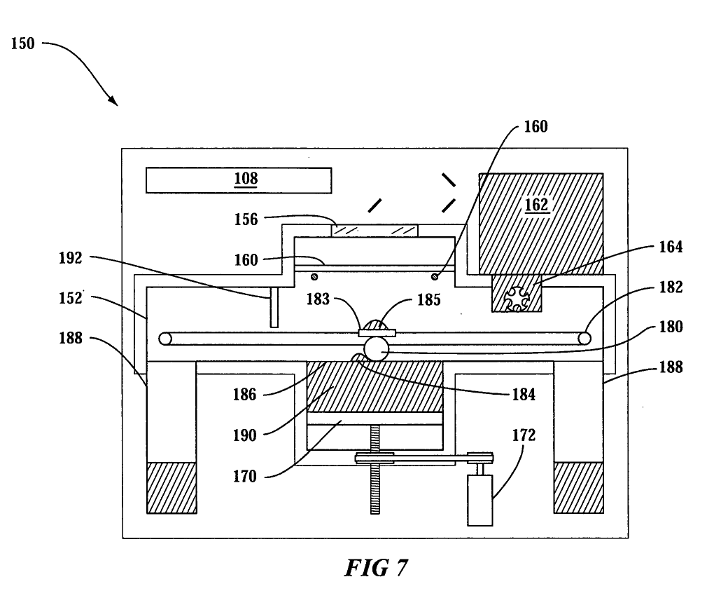

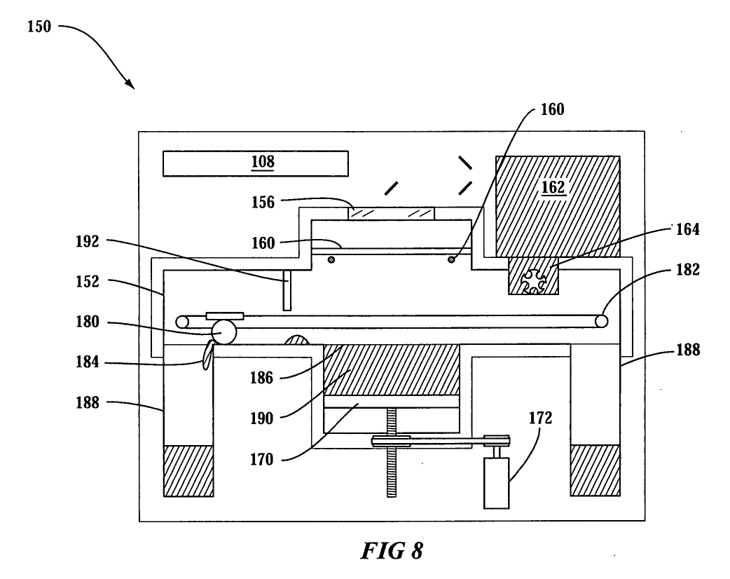

In a next step, shown in FIG. 6, a second powder wave 185 is fed onto the powder support surface or powder carrying structure 183 on the top of the roller mechanism 180. After scanning by the laser of the current layer the next step, shown in FIG. 7, begins. The roller mechanism 180 is activated and traverses completely across the system, spreading the first layer of pre-heated powder from the first parked powder wave 184 across the target area 186, while carrying the second powder wave 185 for creating the second layer of powder on powder support surface 183 of the roller mechanism 180. In the next step, shown in FIG. 8, a mounted stationary blade 192 dislodges the second powder wave 185 for creating the second layer of powder off of the powder support surface 183 of the top of roller mechanism 180 as the roller mechanism passes under the blade, depositing the second powder wave 185 on the floor of the process chamber 152 adjacent the second opposing side of the target area 186 while the roller mechanism 180 proceeds to feed any excess powder into the overflow receptacle 188.

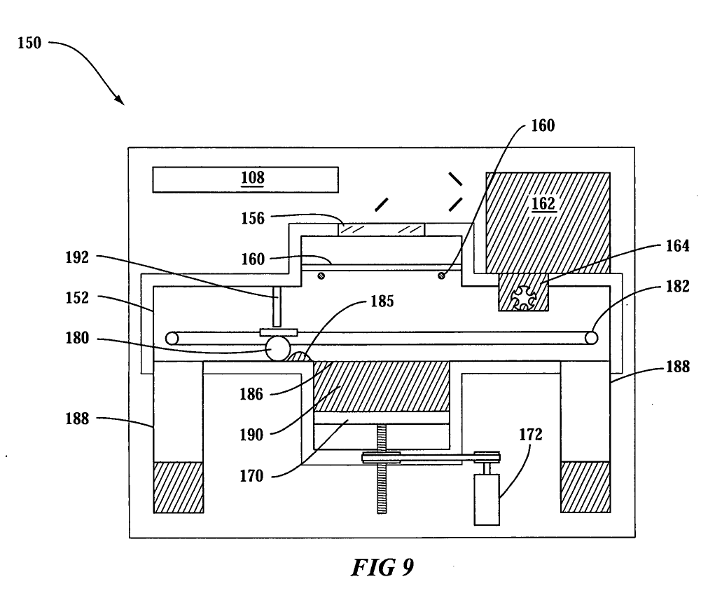

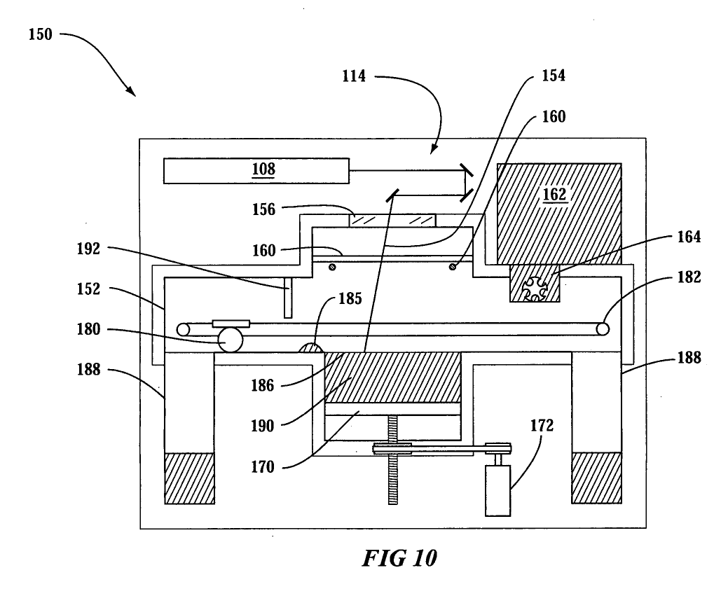

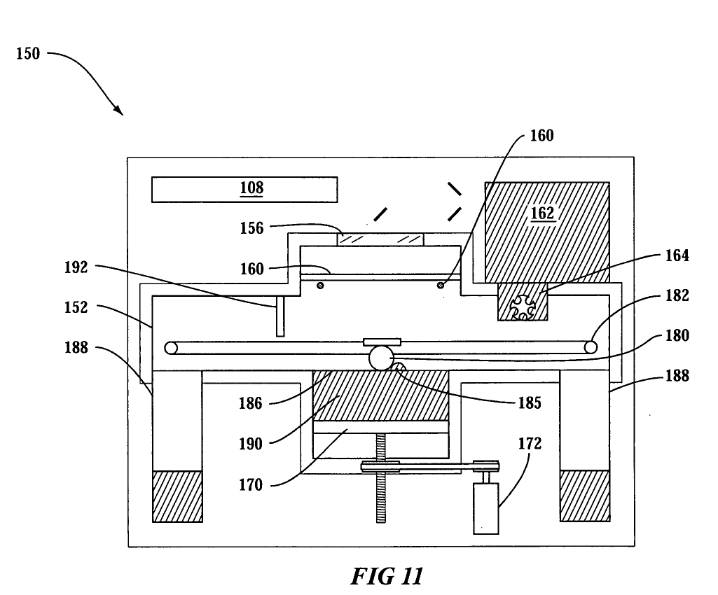

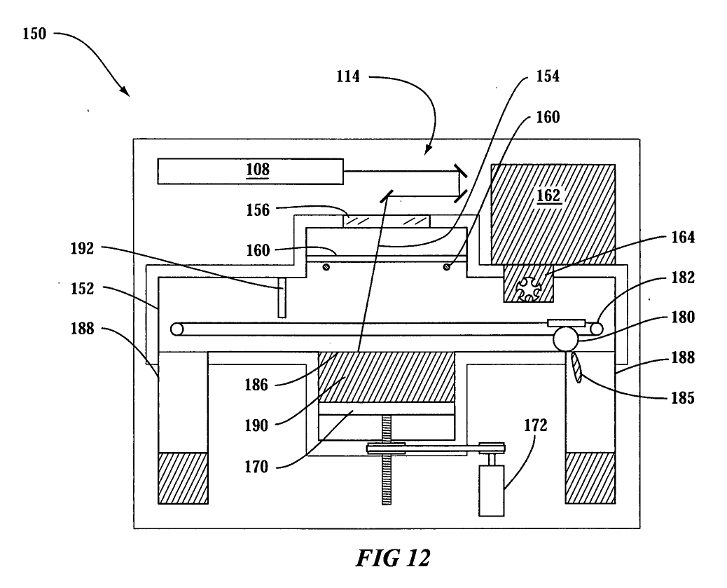

In the next step, shown in FIG. 9, the roller mechanism 180 immediately reverses and moves to park the second powder wave 185 near the part bed 190 and in sight of the radiant heating elements 160 sufficiently close to receive heating effect from them. In the next step of this preferred embodiment shown in FIG. 10 the roller mechanism 180 moves back and parks while the laser scanning action is completed and the quantity of powder in the second powder wave 185 is pre-heated by the radiant heating elements 160. After the laser scanning action is complete the roller mechanism 180 is then activated and moves to spread the second quantity of powder in the second powder wave 185 over the surface of the target area 186 as shown in FIG. 11. After leveling the powder the roller mechanism 180, as seen in FIG. 12, proceeds to the end of its run and drops any excess powder into the overflow receptacle 188. This completes the cycle and the next cycle is ready to proceed as shown in FIG. 3.

This inventive design concept reduces a laser sintering machine in both footprint (the horizontal width of the build chamber) and in mechanical mechanisms. The present invention now employs only one feed hopper, one piston, and preferably only one set of radiant heater elements. The reduced size of the build chamber improves the temperature control and temperature response of the system.

While the invention has been described above with references to specific embodiments, it is apparent that many changes, modifications and variations in the materials, arrangement of parts and steps can be made without departing from the inventive concept disclosed herein. Accordingly, the spirit and broad scope of the appended claims is intended to embrace all such changes, modifications and variations that may occur to one of skill in the art upon a reading of the disclosure. For example any suitable device such as a skive, roller or brush can be used to dislodge or remove the quantity of powder in the second powder wave from the powder carrying surface or structure of the specific spreading mechanism employed, whether a roller, wiper blade or other suitable device. All patent applications, patents and other publications cited herein are incorporated by reference in their entirety.

1. A method for forming a three dimensional article by laser sintering comprising the steps of:
(a) depositing, in a first depositing step, a first quantity of powder on a first side of a target area;
(b) spreading, in a first spreading step, the first quantity of powder with a spreading mechanism to form a first layer of powder;
(c) directing an energy beam over the target area causing the first layer of powder to form an integral layer;
(d) depositing, in a second depositing step, a second quantity of powder on an opposing second side of the target area;
(e) spreading, in a second spreading step, the second quantity of powder with the spreading mechanism to form a second layer of powder;
(f) directing the energy beam over the target area causing the second layer of powder to form a second integral layer bonded to the first integral layer;
(g) repeating steps (a) to (f) to form additional layers that are integrally bonded to adjacent layers so as to form a three dimensional article, wherein the first depositing step comprises feeding the first quantity of powder in front of the spreading mechanism and feeding the second quantity of powder on the spreading mechanism wherein the second quantity of powder is carried during the first spreading step from the first side to the second side of the target area and the second depositing step comprises dislodging the second quantity of powder from the moving spreading mechanism by use of a stationary blade.

2. The method of claim 1 further comprising using a roller as the spreading mechanism.

3. The method of claim 2 further comprising using a counter-rotating roller.

4. The method of claim 1 further comprising using a wiper blade as the spreading mechanism.

5. The method of claim 1 further comprising using a laser beam in the directing step.

6. The method of claim 5 further comprising using a carbon dioxide laser to provide the laser beam.

7. The method of claim 1 further comprising depositing the quantity of powder from an overhead feed mechanism onto a powder carrying structure on the spreading mechanism.

8. The method of claim 7 further comprising dislodging the powder from the powder carrying structure on a side adjacent the target area.

9. An apparatus for producing parts from a powder comprising in combination:
(a) a chamber having a target area at which an additive process is performed, the target area having a first side and an opposing second side;
(b) means for fusing selected portions of a layer of powder at the target area;
(c) a powder feed hopper located above and on the first side of the target area for feeding the powder into the chamber;
(d) means for spreading a first layer of powder over the target area while carrying a second quantity of powder to the opposing second side of the target area, the second quantity of powder to be used for forming a second layer of powder;
(e) means for depositing the second quantity of powder on the opposing second side of the target area; and
(f) means for spreading the second quantity of powder over target area.

10. The apparatus of claim 9 wherein the means for spreading comprises:
(a) a roller;
(b) a motor coupled to the roller for moving the roller across the target area to level the first layer of powder; and
(c) a carrying structure above the roller to receive and carry the second quantity of powder for depositing on the opposing second side of the target area.

11. The apparatus of claim 10 wherein the means for depositing the second quantity of powder on the second side of the target area comprises a device for dislodging the second quantity of said powder off of the carrying structure.

12. The apparatus of claim 10 wherein the means for fusing selected portions of a layer of the powder at the target area comprises:
(a) a energy beam;
(b) an optics mirror system to direct the energy beam; and
(c) energy beam control means coupled to the optics mirror system including computer means, the computer means being programmed with information indicative of the desired boundaries of a plurality of cross-sections of the part to be produced.

13. The apparatus of claim 12 wherein the energy beam is a laser energy beam.

14. The apparatus of claim 11 wherein the device for dislodging further comprises a stationary blade.

15. The apparatus according to claim 9 further comprising:
(a) a wiper blade;
(b) a motor coupled to the wiper blade for moving the wiper blade across the target area to spread the first layer of powder; and
(c) a carrying structure above the wiper blade to receive and carry the second quantity of powder for depositing on the opposing second side of the target area.
